(19) United States
(12) Patent Application Publication
(10) Pub. No.: US 2009/0002669 A1
(43) Pub. Date: Jan. 1, 2009

(54) ULTRAVIOLET LIGHT-EMITTING DIODE EXPOSURE APPARATUS FOR MICROFABRICATION

(75) Inventors: Rong Liu, Pleasanton, CA (US); Evan Palmer, Mountain View, CA (US)

Correspondence Address: Dorsey & Whitney LLP;US Bank Center, 1420 Fifth Avenue, Suite 3400, Seattle, WA, 98101-4010, US

(73) Assignee: Optical Associates, Inc., San Jose, CA (US)

(21) Appl. No.: 12/163,645

(22) Filed: Jun. 27, 2008

Related U.S. Application Data
(60) Provisional application No. 60/937,757, filed on Jun. 29, 2007.

(51) Int. Cl. G03B 27/32; G03B 27/54

(52) U.S. Cl. 355/67; 355/77

(57) ABSTRACT

An exposure apparatus for use in optical lithography can include a holder and a plurality of UV-LED modules carried by the holder and disposed in an array. A respective plurality of collimating lenses can be disposed in an array corresponding to the array of UV-LED modules. The plurality of UV-LED modules and the respective plurality of collimating lenses can provide a respective plurality of distinct beams of UV light. The plurality of collimating lenses may be spaced from the plurality of UV-LED modules and spaced from the exposure plane and have an optical configuration providing a composite beam of UV light formed from the plurality of distinct beams of UV light in which each beam inside the periphery of the array overlaps each adjacent beam by at least 70% at the exposure plane. A method for directing light onto an exposure plane in an optical lithography procedure is provided.

### CROSS-REFERENCE TO RELATED APPLICATION

The application claims priority to U.S. provisional patent application No. 60/937,757 filed on Jun. 29, 2007.

### FIELD OF THE INVENTION

The present invention pertains to light sources and more particularly to light sources for optical lithography applications.

### BACKGROUND

Optical lithography is a commonly used microfabrication processes. It is widely used in semiconductor chip manufacturing and microfluidics industries. Optical lithography involves exposing a substrate to a collimated uniform beam of light emanated from a light source and further developing the substrate thereby creating a pattern on the substrate. Various methods and approaches to optical lithography are known in the art which use a mercury lamp as a light source. See, for example, U.S. Pat. Nos. 4,024,428, 4,117,375, and RE30,571. Various drawbacks are associated with the use of mercury lamps including environmental concerns, unwanted infrared radiation requiring filtering optics, high cost of ownership due to a relatively short life of mercury lamps, and lack of an ability to easily scale up the size of the light source. What is needed, therefore, is an exposure apparatus without infrared radiation, that has a low cost of ownership, can be easily scaled as large or small as necessary, and that is environmentally conscious.

### BRIEF SUMMARY

An exposure apparatus for use in optical lithography with respect to an exposure plane is provided and can include a holder and a plurality of ultraviolet light-emitting diode (“UV-LED”) modules carried by the holder and disposed in an array. A respective plurality of collimating lenses can be disposed in an array corresponding to the array of UV-LED modules. The plurality of UV-LED modules and the respective plurality of collimating lenses can provide a respective plurality of distinct beams of UV light. The plurality of collimating lenses may be spaced from the plurality of UV-LED modules and spaced from the exposure plane and have an optical configuration for providing a composite beam of UV light formed from the plurality of distinct beams of UV light in which each beam inside the periphery of the array overlaps each adjacent beam by at least 70% at the exposure plane. A method for directing light onto an exposure plane in an optical lithography procedure is provided.

### BRIEF DESCRIPTION OF THE DRAWINGS

FIG. 1 is an exploded view of an arrangement of a UV-LED array and a lens array according to certain embodiments.

FIG. 2 is a schematic drawing illustrating light beam paths according to certain embodiments.

FIG. 3 is a plan view of the percentage of overlap between adjacent light beams at an exposure plane.

### DETAILED DESCRIPTION

The exposure apparatus of the present invention is directed toward use in optical lithography. The exposure apparatus includes a light source that directs light through a collimating lens or lenses. In the optical lithography process, the light beams emitted from the light source are collimated by the lenses to a certain degree and are directed to an exposure plane. The exposure plane may include a substrate coated with a photoresist and may be masked to achieve a desired pattern.

The exposure apparatus of the present invention may be carried by a frame 5 for positioning and orienting the exposure apparatus. The frame 5 may be further positioned within a mask aligner. In some embodiments, the frame 5 may be fixed. In other embodiments, the frame 5 may be moveable and yet fixable so as to be stationary during the exposure process.

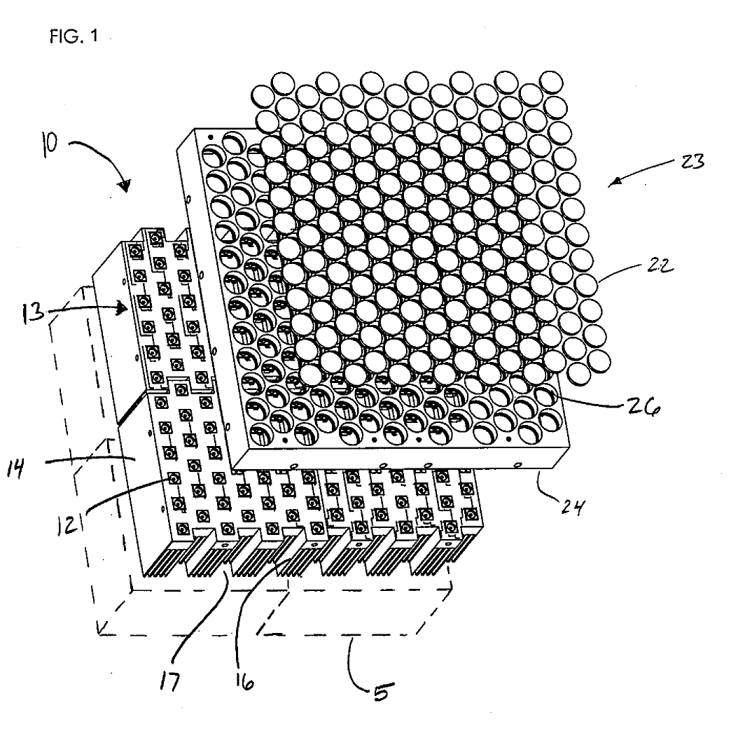

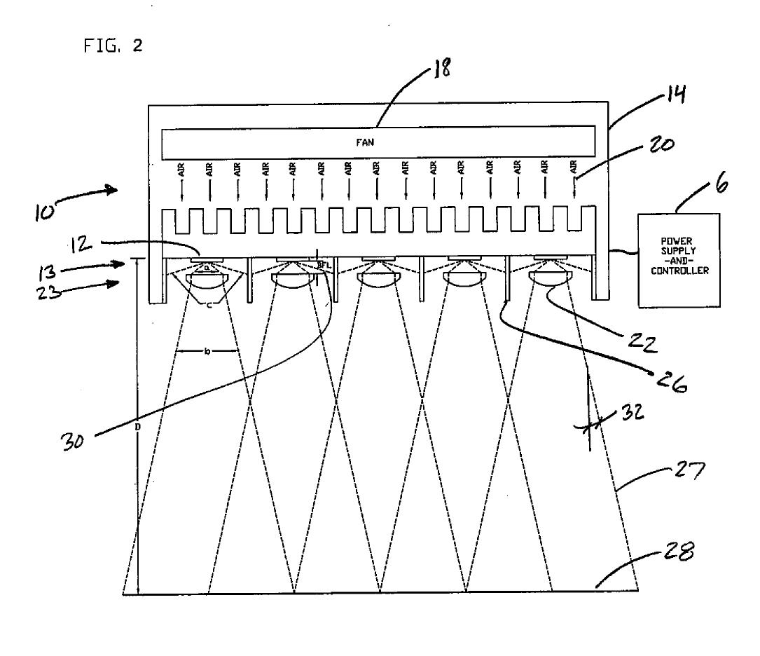

The exposure apparatus includes a light source 10 comprising high-power UV-LED modules 12 arranged in an array 13 on a holder or holders 14. The holders 14 may be any shape and may be connectable along their perimeter to additional holders 14 as shown in FIG. 1. Preferably, the holders 14 are of a shape that is repeatable to provide for increasing the size of the UV-LED array 13 by adjoining multiple holders 14. This may include square or rectangular shapes lending themselves to repeatable expansion. Additionally, the perimeter of the holders may include nesting or interlocking projections 16 and recesses 17 to further assist the connection of multiple holders 14. Thus, one or more holders 14 may be included in the exposure apparatus depending on the size of the light beam needed for a given application. In FIG. 1, the exposure apparatus is depicted as having four holders 14. As shown in FIG. 2, the holders 14 may also take the form of a heat sink, which is cooled by a fan 18 which circulates air 20 to carry heat away from the UV-LED modules 12. Those skilled in the art will understand and appreciate that several other types of heat sinks are known in the art including those that are cooled by air or liquid and are thus within the scope of the invention.

The array 13 of UV-LED modules 12 on the holder 14 can be arranged in any pattern including a square or rectangular pattern. Preferably, as shown in FIG. 1, the array 13 is arranged in a hexagonal pattern where each UV-LED module 12 has six nearest neighbors resulting in a compact array.

The high-power UV-LED modules 12 emit light in the wavelength range between 345 nm and 385 nm, with a peak wavelength of 365 nm. This peak wavelength is commonly referred to as the i-line, which is most commonly used in optical lithography. Other commonly used spectral regions are the g-line and h-line with wavelengths of 436 nm and 405 nm respectively.

The high-power UV-LED modules 12 may be directed in a substantially parallel direction along which corresponding collimating lenses 22 may also be arranged in an array 23. The lens array 23 may correspond to the UV-LED array 13 in that each lens 22 may correspond to a respective UV-LED module 12, as shown in FIG. 1. As with the UV-LED holders 14, the lens array 23 may be arranged on a single holder 24 or arranged on several holders 24. The UV-LED array 13 and the lens array 23 may be aligned with respect to each other so that the light emanating from each UV-LED module 12 is collimated by a corresponding lens 22.

The exposure apparatus may also include baffles 26 arranged between adjacent lenses 22. As shown in FIG. 1, these baffles 26 may extend from the lenses toward the UV-LED modules 12. They may extend all the way to the UV-LED modules 12 or stop short. Additionally, they may extend away from the UV-LED modules 12 and extend beyond the lenses 22. It is noted that the baffles 26 shown in FIG. 2 are schematic.

The light beam emitted by the UV-LED modules 12 passes through the corresponding lenses 22 and may be collimated to a certain extent. The level of collimation depends on the focal length of lens 22 and the distance the lens 22 is spaced from the UV-LED module 12. As shown in FIG. 2, the light beam emitted by the UV-LED module 12 forms the shape of a cone. The cone of light with boundary a, is refracted by the corresponding collimating lens 22. Light emitted by the UV-LED modules 12 at higher angles, represented by boundary c, is blocked by the baffles 26, and thus does not reach the exposure plane 28. The UV-LED modules 12 are spaced from the respective lenses 22 a distance approximately equal to the back focal length (BFL) 30 of the lenses 22 so that the refracted cone of light 27 emerging from each lens 22, with boundary b, is nearly collimated and has a half-divergence angle 32 ranging from one to eight degrees (exaggerated in the schematic drawing of FIG. 2), depending on the requirements of a given application. The slight half divergence angle 32 allows the beam to expand as it reaches the exposure plane 28 situated at a distance D from the UV-LED array. As each beam expands, it overlaps each adjacent beam defining a percentage of overlap. The amount of overlap is dependent on the spacing of the UV-LED modules 12 in the array 13, the half divergence angle of each individual beam, and the distance D between the UV-LED modules 12 and the exposure plane 28. The half divergence angle of each individual beam is further dependent the optical configuration of the lenses 22, which is determined by the focal lengths of the lenses 22 and the distance between the lenses 22 and the UV-LED modules 12.

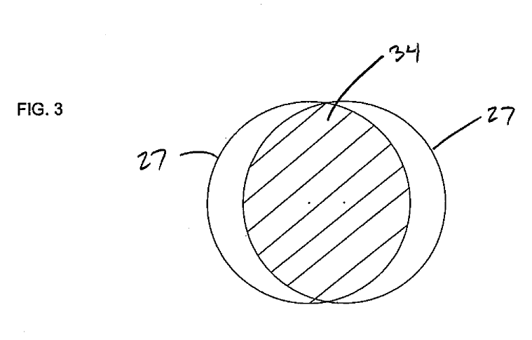

FIG. 3 is a plan view of two overlapping cones of light 27. The percentage of overlap may be calculated by dividing the overlapping area 34 by the area of the individual cone of light 27. In one preferred embodiment of the invention, each beam inside the periphery of the array overlaps each adjoining beam by 70% to 90%, preferably by 80% to 90% and more preferably by approximately 80%. The hexagonal type array 13 discussed above and shown in FIG. 1 allows for a compact arrangement of the UV-LED modules 12 and lenses 22 contributing to more overlap 34 between the cones of light 27. Additionally, the distance between the UV-LED modules 12 and the lenses 22 can be adjusted to increase or decrease the half divergence angle 32 of the cone of light 27. Thus, for a given distance D, between the UV-LED modules 12 and the exposure plane 28, the exposure apparatus can be adjusted to provide more or less overlap 34 between adjacent cones of light 27. Where the distance D is large enough, each beam in the array may overlap each adjoining beam by 70% or more at the exposure plane 28.

In use, an exposure apparatus is provided including a UV-LED holder or holders 14 configured on a frame 5, the holders 14 including an array 13 of UV-LED modules 12. A corresponding lens holder or holders 24 containing a corresponding array 23 of lenses 22 is then positioned in alignment with the UV-LED modules 12. The lenses 22 are positioned at a distance away from the UV-LED modules 12 to provide a beam of light in the form of a cone with a half-divergence angle 32 ranging from 1 to 8 degrees. Additionally, the exposure apparatus is positioned near an exposure plane 28. The distance between the UV-LED array 13 and the exposure plane 28 together with the distance between the UV-LED modules 12 and the lenses 22 are then adjusted as allowable to provide the most preferable percentage of overlap of the light beams.

More particularly, in optical lithography, an exposure apparatus as described may be positioned near and directed at a substrate coated with a photoresist. The substrate may be overlaid with a mask made of chrome with a desired pattern. In this application, the mask-substrate assembly may be exposed to a collimated and uniform beam of light provided by the exposure apparatus. After exposure, the substrate may be developed in a chemical solution. Most photoresists are sensitive to ultraviolet light and the photoresist in the area that has been exposed to the light will be dissolved and the rest will remain, or vice versa, depending on whether a positive or negative photoresist is used. As a result, the pattern on the mask may be transferred to the substrate.

The overlapping light beams of the UV-LED modules 12 form an aggregate or composite beam. One advantage of this is that the substantial overlap allows for compensation for variations in the intensity of the neighboring light beams and may result in a composite beam that has an intensity that is uniform within ±5% over a certain area inside the periphery of the array. The uniformity may be calculated by using the formula (Iₘₐₓ−Iₘᵢₙ)/(Iₘₐₓ+Iₘᵢₙ)*100%, where I is the intensity of the composite beam. Specifically, the substantial overlap may ensure that the uniformity of the composite beam is less sensitive to slight variations in the optical output of each UV-LED module 12 or a slight misalignment of a UV-LED module 12 with respect to the corresponding collimating lens 22.

An additional advantage is that the size of the arrays 13, 23 may be increased or decreased by adding or removing holders 14, 24. Moreover, the UV-LED and lens arrays 13, 23 of each holder 14, 24 may be populated, by including or activating selected UV-LED modules 12, as specifically required by a particular application to achieve a desired size or shape. Thus, the current exposure apparatus has at least two degrees of adjustability involving a selected number of holders 14, 24 and a selected number of UV-LED modules and lenses 12, 22 within each holder 14, 24. In this manner, the size of the composite beam can be scaled and a composite beam shape of various configurations, such as square, rectangle, circular, or annular shapes, can be formed from the plurality of collimated beams. By comparison, Mercury arc lamps that are used for applications requiring very large collimated beams can require up to 50 KW in power, requiring elaborate water cooling systems and large, expensive optics to filter and collimate the beam.

In addition to beam uniformity and adjustability, the aforementioned UV-LED exposure apparatus provides a collimated light beam that allows the formed features of the optical lithography process to have straight walls. The apparatus also has several advantages over mercury-arc-lamp-based exposure systems. The narrow spectral characteristics of the UV-LED modules 12 ensures that most of the emitted light is in the useful spectral range. In addition, there is no unwanted IR radiation in the UV-LED exposure system. Therefore, no filtering optics are required as in mercury-arc-lamp-based exposure systems. The UV-LED modules 12 also have much longer lifetimes than those of mercury arc lamps. As a result, the cost of ownership can be as much as 50% lower than that of an arc-lamp-based light source. Also, UV-LED modules are mercury free which addresses the worldwide trend towards a reduction of hazardous substances in industrial products of all types.

In the foregoing description, embodiments of the present invention, including preferred embodiments, have been presented for the purpose of illustration and description. They are not intended to be exhaustive or to limit the invention to the precise forms disclosed. The embodiments were chosen and described to provide the best illustrations of the principals of the invention and its practical application, and to enable one of ordinary skill in the art to utilize the invention in various embodiments and with various modifications as are suited to the particular use contemplated. The scope of the invention should be determined by the appended claims when interpreted in accordance with the breadth they are fairly, legally, and equitably entitled.

What is claimed is:

1. An exposure apparatus for use in optical lithography with respect to an exposure plane comprising at least one holder, a plurality of UV-LED modules carried by the at least one holder and disposed in an array and a respective plurality of collimating lenses disposed in an array corresponding to the array of UV-LED modules, the plurality of UW-LED modules and the respective plurality of collimating lenses providing a respective plurality of distinct beams of UV light, the plurality of collimating lenses being spaced from the plurality of UV-LED modules and being spaced from the exposure plane and having an optical configuration for providing a composite beam of UV light formed from the plurality of distinct beams of UV light in which each beam inside the periphery of the array overlaps each adjacent beam by at least 70% at the exposure plane.

2. The apparatus of claim 1 wherein each collimating lens in the plurality of collimating lenses is spaced from the respective UV-LED module so that the respective distinct beam of UV light has a half divergence angle from one to eight degrees.

3. The apparatus of claim 2 wherein the composite beam has a substantially uniform intensity that varies by no more than +/−5% within an area inside the periphery of the array.

4. The apparatus of claim 3 wherein the array of collimating lenses is positioned parallel to the array of UV-LED modules.

5. The apparatus of claim 1 wherein each collimating lens in the plurality of collimating lenses is spaced apart from adjacent collimating lenses in the plurality of collimating lenses.

6. The apparatus of claim 5 further comprising a baffle wall disposed between each collimating lens and adjacent collimating lenses.

7. The apparatus of claim 6 wherein a baffle wall extends between each UV-LED and adjacent UV-LEDs.

8. The exposure apparatus of claim 1, wherein the at least one holder further comprises a heat sink.

9. The exposure apparatus of claim 8, further comprising a cooling means to cool the heat sink.

10. The exposure apparatus of claim 9, wherein the cooling means is a fan configured to circulate air in and around the heat sink.

11. The exposure apparatus of claim 1, wherein each beam inside the periphery of the array overlaps each adjacent beam from 70%-90%.

12. The exposure apparatus of claim 1, wherein the array of UV-LED modules are arranged in a hexagonal pattern.

13. A method for directing light onto an exposure plane in an optical lithography procedure comprising providing a plurality of light-emitting diodes arranged in a planar array and emitting a respective plurality of beams of light and focusing the plurality of beams of light onto the exposure plane so that adjacent beams overlap at least 70% at the exposure plane.

14. The method of claim 13, further comprising providing baffles disposed between the light-emitting diodes.

15. The method of claim 13, wherein adjacent beams overlap from 70% to 90%.

16. The method of claim 13, wherein focusing the plurality of beams of light comprises providing a plurality of lenses arranged in a planar array corresponding to the planar array of light emitting-diodes.

17. The method of claim 16, wherein focusing the plurality of beams of light further comprises spacing the plurality of lenses from the plurality of light-emitting diodes a distance approximately equal to a back focal length of the plurality of lenses.

18. The method of claim 17, wherein the lenses are further spaced so that the plurality of beams of light have a half-divergence angle ranging from 1 to 8 degrees.
